(19) United States
(12) Patent Application Publication
(10) Pub. No.: US 2020/0151837 A1
(43) Pub. Date: May 14, 2020

(54) METHOD FOR PERFORMING LEGAL CLEARANCE REVIEW OF DIGITAL CONTENT

(71) Applicant: Sony Interactive Entertainment LLC, San Mateo, CA (US)

(72) Inventor: Riley R. Russell, San Mateo, CA (US)

(21) Appl. No.: 16/184,684

(22) Filed: Nov. 8, 2018

(51) Int. Cl. G06Q 50/18; G06N 3/08

(52) U.S. Cl. CPC G06Q 50/184; G06N 3/08

(57) ABSTRACT

Automated clearance review of digital content may be implemented with artificial intelligence (AI) models trained to identify items appearing in the digital content presentation that are known to be clear of intellectual property rights encumbrances or are likely to be generic, ignore such items, and determine which remaining items are potentially subject intellectual property rights encumbrances. A report may then be generated that identifies those remaining items.

### FIELD OF THE DISCLOSURE

This disclosure is related to analysis of media content and more specifically to analysis of digital content for legal clearance.

### BACKGROUND

The legal regulatory and politically conscious landscape for digital content is increasingly complex. Items of digital content may be subject to various legal protections, such as copyright and trademark protection. In addition, images of certain persons, places and objects appearing in digital content may be subject to a right to publicity. In other instances, images, symbols or shapes may have developed a socially negative connotation or meaning to some or many individuals or groups. Producers of digital content, e.g., motion pictures, television programs, musical recordings, video games, and the like, subject new content to a rigorous process of review to determine that no portion of the content infringes on the rights of another. The process generally involves one or more persons reviewing the content item as it is presented, noting items appearing in the content and subjecting these items to review for clearance. An item may be cleared if it is determined to be in the public domain or if the content producer can secure or has already secured licensing rights to use those items in the media content. When this type of clearance is not possible, the digital content may need to be edited to remove problematic items.

Because clearance review is done manually it is time consuming, expensive, and subject to human error. Furthermore, given the sheer volume of digital content and items subject to legal protection it is difficult to determine which persons or objects appearing in digital content require clearance.

It is within this context that aspects of the present disclosure arise.

### BRIEF DESCRIPTION OF THE DRAWINGS

FIG. 1A is a schematic diagram illustrating a method for legal clearance review of digital content according to aspects of the present disclosure.

FIG. 1B is a schematic diagram illustrating operation of an artificial intelligence (AI) models in implementing the method for legal clearance review of digital content of FIG. 1A.

FIG. 1C is a schematic diagram illustrating generation of a report from categorization items in digital content according to aspects of the present disclosure.

FIG. 2A is a simplified node diagram of a recurrent neural network for use in legal clearance review of digital content according to aspects of the present disclosure.

FIG. 2B is a simplified node diagram of an unfolded recurrent neural network use in legal clearance review of digital content according to aspects of the present disclosure.

FIG. 2C is a simplified diagram of a convolutional neural network for use in legal clearance review of digital content according to aspects of the present disclosure.

FIG. 3 is a block diagram depicting the method of sound categorization and classification using trained sound categorization and classification Neural Networks according to aspects of the present disclosure.

FIG. 4 depicts a block diagram of a system for implementing legal clearance review of digital content according to aspects of the present disclosure.

### DETAILED DESCRIPTION

### Introduction

According to aspects of the present disclosure Artificial Intelligence (AI) could be used to automate certain aspects of review digital content for items that are potentially subject to one or more intellectual property (IP) encumbrances, e.g., trademark, copyright, right of publicity, trade secret, and the like.

AI models may be trained to analyze video images from a digital content presentation and identify relevant items, e.g., persons, objects, places, buildings, works of art, or text, appearing therein. An AI model may be similarly trained to analyze audio from the digital content presentation and identify other relevant items, e.g., sounds, individual voices, dialogue, or music appearing therein. Once an item has been identified and categorized it may be compared to a database of similar items that are known to be free of IP encumbrances or generic. By way of example, and not by way of limitation, items may be known to be free of IP encumbrances, e.g., because they are already licensed from the IP right holder by the creator, distributor, or exhibitor of the digital content presentation. Alternatively, items might be clear of encumbrances because the relevant IP rights are already owned by the creator or distributor of the digital content presentation. This may occur, for example, where the creator or distributor of the digital content presentation (e.g., a video game) has created other related content presentations (e.g., other video games or related motion pictures) and characters from related content presentations appear in the digital content presentation. Another way that an item may be known to be free of IP encumbrances is if the item in question is already in the public domain, e.g., as a result of IP rights having expired.

As used herein the term generic is most often associated with trademarks. As is commonly understood by those skilled in the intellectual property arts, a generic trademark, also known as a genericized trademark or proprietary eponym, is a trademark or brand name that, due to its popularity or significance, has become the generic name for, or synonymous with, a general class of product or service, usually against the intentions of the trademark's holder. Thermos, Kleenex, ChapStick, Aspirin, Dumpster, Band-Aid, Velcro, Hoover, and Speedo are examples of trademarks that have become generic in the US and elsewhere.

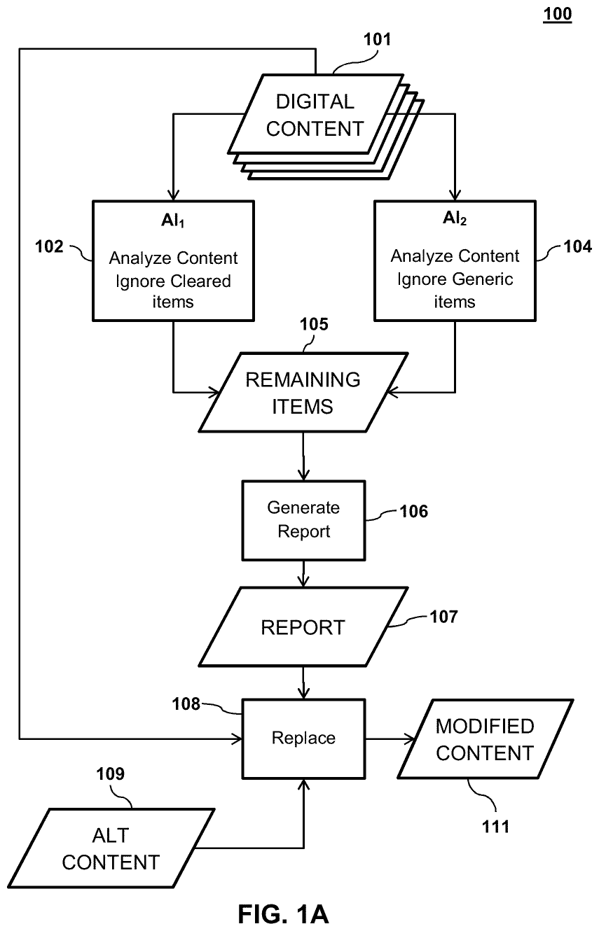

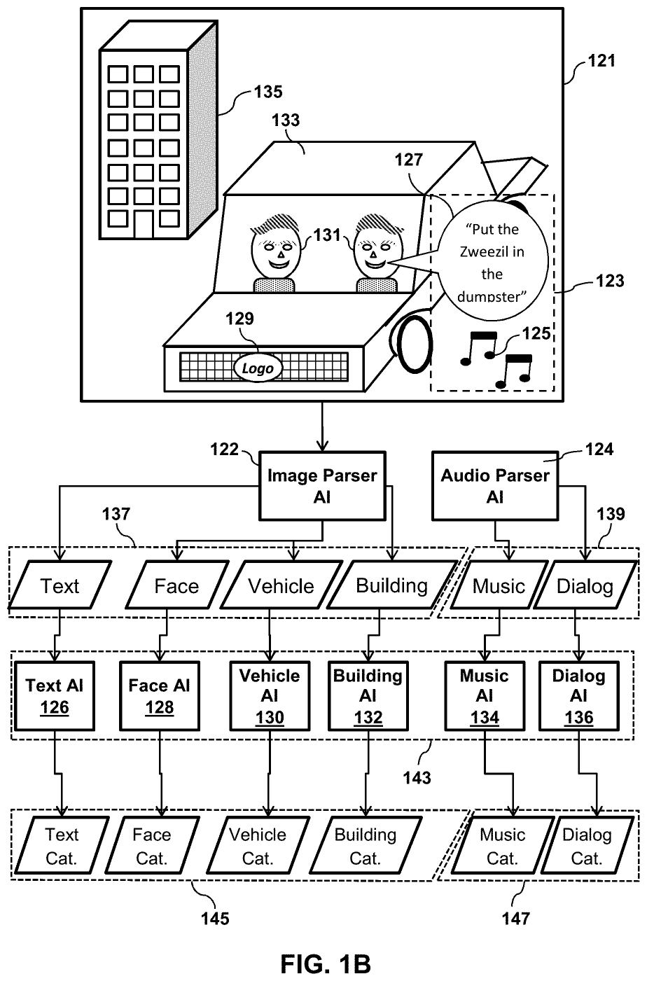

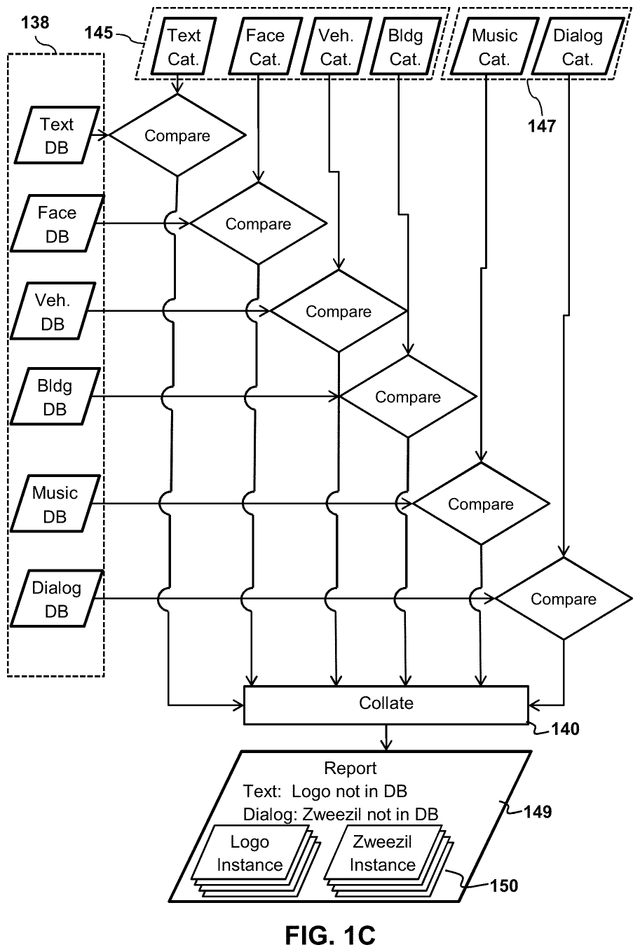

In accordance with aspects of the present disclosure, clearance review may proceed in accordance with the method 100 illustrated in FIG. 1A. A digital content presentation 101 may be analyzed with one or more artificial intelligence (AI) models trained to identify items that do not present clearance problems. For example, a first AI model 102 may be trained to identify items appearing in the digital content presentation that are known to be clear of intellectual property rights encumbrances and a second AI model 104 may be trained to determine which items appearing in the digital content presentation 101 that are not known to be clear but are likely to be generic. The remaining items 105 may then be used to generate 105 a report 107 listing the remaining items according to their categorization. The report may optionally identify where in the presentation 101 each of the remaining items 105 occurs. This facilitates an optional automatic replacement process 108 by which items that are not clear or generic may be replaced with items that are clear. Such replacement may involve digitally changing, blurring, or removing text, faces, vehicles, music, or dialog to generate modified content 111. By way of example, selected remaining items appearing in the digital content presentation 101 may be replaced with corresponding items from a database containing alternative items of content that are known to be clear.

FIGS. 1B-1C illustrate a detailed example of a possible implementation of automated clearance review of digital content in accordance with aspects of the present disclosure. FIG. 1B depicts application of AI to a scene from a video. In this example the scene includes a series of digital video images 121 along with audio data 123, which in this example includes separate tracks for music 125 and dialog 127. The video images 121 and audio data 123 are respectively fed into an image parser AI 124 and an audio parser AI 126. The image parser AI 122 analyzes the images to determine what portions of the images correspond to different classes of items, e.g., text 129, faces 131, vehicles 133, and buildings 135. Those skilled in the art will recognize that these represent only a few of many different possible different classes of items that may be depicted in video images. Other possible classes may include plants, animals, geographic locations, furniture, and works of art. The video parser AI 122 may be include multiple AI each of which is configured to identify individual items in a corresponding class (e.g., text, face, vehicle, building in the illustrated example). By way of example and not by way of limitation the image parser AI may include a standard face detection library such as dlib or openCV as a “face parser” AI to detect the faces at each frame of the video images 121. To facilitate subsequent categorization of the faces, the face parser may identify each instance of a face appearing in the video images 121, determine which instances correspond to the same face and group different instances of the same face together, e.g., by associating each instance with identifying information. Similarly configured AI components may be used for the text, vehicles and buildings in the illustrated example. The audio parser AI 124 may likewise include separate AI components for analyzing the dialogue and music. Analysis of the audio 123 may be greatly facilitated where audio parser AI 124 can access separate audio tracks, e.g., for music, dialogue, and background sounds and distribute them to corresponding music, dialogue, and background sound AI components.

The image parser AI 122 outputs reduced data 137 corresponding to the individual items of the different classes that are depicted in the video images 121. By way of example the reduced information may include one or more best or representative image of a given item. For example, a given face 131 may appear in hundreds or thousands of frames of the video images 121. Not all of these images are needed to identify the person or character belonging to the given face 131. To reduce the amount of information the face parser AI may output portrait and profile images of each different face found in the video images 121. Vehicles 133 or buildings 135 may require more than two images to accurately identify them. In some implementations, the reduced data 137 may include timestamp information or other information identifying when (e.g., which frames) and where (e.g., which part of the frame) each given item appears in the video images 121. Such information can be useful for facilitating review and/or replacement of items that are potentially problematic.

In a similar manner, the audio parser AI 124 may output reduced data 139 corresponding to the individual items of the different classes that are depicted in the audio data 123. By way of example the reduced audio data 139 may include one or more best or representative image of a given item. For example, certain words or sentences may appear multiple times in the dialog 127 or the same musical theme may be repeated, perhaps in different keys or different musical styles. Not all of these instances are needed to identify the word, sentence or music. By way of example, to reduce the amount of information the Audio parser AI 124 may output a best example of sounds corresponding to the same word or sentence. Items of music 125 may require more than two images to accurately identify and categorize them. For example, different recordings of the same musical piece may appear in the data 125. However, some of these recordings may be in the public domain and others may not. In some implementations, the reduced data 139 may include timestamp information or other information identifying when (e.g., which frames) each given item appears in the audio data 123. Such information can be useful for facilitating review and/or replacement of items that are potentially problematic.

The reduced video data 137 and reduced audio data 139 are then sent to separate video categorization AI components 141 and audio categorization AI components 143 to identify the corresponding items appearing in the video images 121 and audio data 123, respectively. In the illustrated example, the video categorization AI components 141 include separate AI components for analyzing reduced video data 137 for text 126, faces 128, vehicles 130, and buildings 132. Likewise, the audio categorization components 143 may include separate AI components for analyzing reduced audio data 139 for music 134 and dialog 136. In some implementations, where the audio 123 includes sound effects the audio parser 124 may separate these out as well and the audio categorization AI components 143 may include a separate sound effects AI to analyze and categorize these. An example of such sound effects categorization is described in U.S. patent application Ser. No. 16/147,331 to Arindam Jati et al., filed Sep. 28, 2018 and entitled “SOUND CATEGORIZATION SYSTEM”, the entire contents of which are incorporated herein by reference.

The video categorization AI components 141 may utilize corresponding trained databases (not shown) with labeled images of known items in the corresponding classes, e.g., text, faces, vehicles, and buildings in the illustrated example. The audio categorization AI components 143 may utilize corresponding trained databases (not shown) with labeled audio data samples of known items in the corresponding classes, e.g., music and dialog. The video categorization AI components 141 output video categorization data 145 corresponding to the items represented by the reduced video data 137 that appear in the video images 121. By way of example, the text categorization AI component 126 may output data in the form of strings corresponding to each instance of text 129 depicted in the video images 121. In some instances such text categorization data may also identify the font of the depicted text. In a like manner the face categorization AI component 128 may output data in the form of text strings identifying the person or character corresponding to the depicted faces. The vehicle categorization AI component 130 and building categorization component 132 may likewise output data identifying the depicted vehicles and buildings, respectively.

The audio categorization AI components 143 output audio categorization data 147 corresponding to the items represented by the reduced audio data 139 that occur in the audio data 123. By way of example, the music categorization AI component 134 may output data in the form of text strings identifying musical compositions that occur in the music 125 by title, composer, recording artist, and the like. Similarly, the dialog categorization AI component 136 may output lists of particular identified words, e.g., particular nouns, used in the dialog 127.

Generating the categorization, while useful is only part of the IP clearance review. The number of identified items in the video categorization data 145 and audio categorization data 147 may potentially be quite large. It is therefore desirable to reduce the number of items that need to be reviewed by culling from the data those items that are known to be clear of IP encumbrances, and by creating a list of unique items, objects and sounds without having to review every instance of each item, object or sound that occurs in a scene. FIG. 1B illustrates a non-limiting example of how such data reduction might be accomplished. In the illustrated example, the identified items in the video categorization data 145 and audio categorization data 147 may be compared against databases 138 of items that are known to be free of IP encumbrances. As noted above, items may be known to be free of IP encumbrances, e.g., because they are known to be generic, in the public domain, or already licensed from the IP right holder by a relevant entity, e.g., the creator, distributor, or exhibitor of the digital content presentation containing the video images 121 and audio data 123. The categorized items in each class may be compared against items in the corresponding class databases and any matching items may then be flagged. The results may then be collated, as indicated at 140 and any flagged items may be ignored. A report 149 may then be generated listing those items that have not been flagged.

In the example depicted in FIG. 1C, suppose that the actors' faces, and the music are clear of intellectual property rights encumbrances and the building and the word “dumpster” are generic.

The actor's face, and the music, the building, and the word “dumpster” therefore do not appear in the report. Since the “Logo” text and the word “Zweezil” are not in their respective databases the report 149 flags them for further review.

The report 149 may be made more usable by “compressing” the amount of material that must be reviewed by removing or omitting known public domain items, known cleared items. According to aspects of the present disclosure, the report 149 may be configured so that multiple instances of flagged items are reduced in the report so that they are represented by a single object so that they appear only once in the report. By way of example, if Mickey Mouse appears three times in the same presentation, e.g., once on a brick wall of a billboard, on a hat of a person walking down a street and on a bus, “Mickey Mouse” may be identified in the report 149 one time but data reflecting the variations of its use may be available in the report. To facilitate review of multiple instances 150 of the same flagged item, the report 149 may be in electronic form and may include an interactive tool. Such a tool may be configured to show a user the number of instances of flagged items, show a representative image of each of those instances, and provide information that allows the user to quickly navigate through the content item to each of the instances. Such information may refer to an index in a timeline of the content item. In some implementations the information may be in the form of hypertext (e.g., html, xml, or other data) that links to portion of the content item corresponding to the index. In such implementations, the user may be able to navigate to a given flagged instance by clicking on a hypertext link embedded in the report 149.

According to aspects of the present disclosure some types of digital content can be analyzed without requiring an image parser AI 122 and an audio parser AI 124 or the or the corresponding image categorization AI components 141 and audio categorization AI components 143. Certain forms of digital content, e.g., video game content, are in a format in which this information is readily extractable. Specifically, game data typically includes information identifying assets, e.g., vehicles, non-player characters, music, dialog, text, buildings, that appear in the game. Much relevant information about such assets can be extracted directly from game data without having to analyze images or audio.

### Neural Network Training

The AI models that implement automated clearance review of digital content may include one or more of several different types of neural networks and may have many different layers. By way of example and not by way of limitation the classification neural network may consist of one or multiple convolutional neural networks (CNN), recurrent neural networks (RNN) and/or dynamic neural networks (DNN).

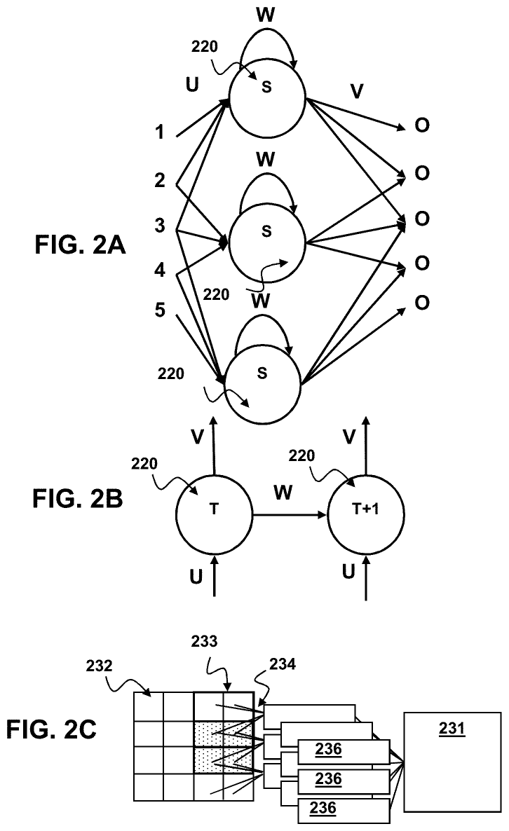

FIG. 2A depicts the basic form of an RNN having a layer of nodes 220, each of which is characterized by an activation function S, one input weight U, a recurrent hidden node transition weight W, and an output transition weight V. It should be noted that the activation function S may be any non-linear function known in the art and is not limited to the (hyperbolic tangent (tanh) function. For example, the activation function S may be a Sigmoid or ReLu function. Unlike other types of neural networks, RNNs have one set of activation functions and weights for the entire layer. As shown in FIG. 2B the RNN may be considered as a series of nodes 220 having the same activation function moving through time T and T+1. Thus, the RNN maintains historical information by feeding the result from a previous time T to a current time T+1.

There are a number of ways to configure the weights, U, W, and V. The input weight U may be applied based on the Mel-frequency spectrum. The weights for these different inputs could be stored in a lookup table and be applied as needed. There could be default values that the system applies initially. These may then be modified manually by the user or automatically by machine learning.

In some embodiments, a convolutional RNN may be used. Another type of RNN that may be used is a Long Short-Term Memory (LSTM) Neural Network which adds a memory block in a RNN node with input gate activation function, output gate activation function and forget gate activation function resulting in a gating memory that allows the network to retain some information for a longer period of time.

FIG. 2C depicts an example layout of a convolution neural network such as a CRNN according to aspects of the present disclosure. In this depiction, the convolution neural network is generated for an image 232 with a size of 4 units in height and 4 units in width giving a total area of 16 units. The depicted convolutional neural network has a filter 233 size of 2 units in height and 2 units in width with a skip value of 1 and a channel 236 of size 9. For clarity in FIG. 2C only the connections 234 between the first column of channels and their filter windows is depicted. Aspects of the present disclosure, however, are not limited to such implementations. According to aspects of the present disclosure, the convolutional neural network that implements the classification 229 may have any number of additional neural network node layers 231 and may include such layer types as additional convolutional layers, fully connected layers, pooling layers, max pooling layers, local contrast normalization layers, etc. of any size.

As seen in FIG. 2D Training a neural network (NN) begins with initialization of the weights of the NN 241. In general, the initial weights should be distributed randomly. For example, an NN with a tanh activation function should have random values distributed between

$$- \frac{1}{\sqrt{n}} and \frac{1}{\sqrt{n}}$$

where n is the number of inputs to the node.

After initialization the activation function and optimizer is defined. The NN is then provided with a feature or input dataset 242. Each of the different features vector may be provided with inputs that have known labels. Similarly, the Classification NN may be provided with feature vectors that correspond to inputs having known labeling or classification. The NN then predicts a label or classification for the feature or input 243. The predicted label or class is compared to the known label or class (also known as ground truth) and a loss function measures the total error between the predictions and ground truth over all the training samples 244. By way of example and not by way of limitation the loss function may be a cross entropy loss function, quadratic cost, triplet contrastive function, exponential cost, etc. Multiple different loss functions may be used depending on the purpose. The NN is then optimized and trained, using the result of the loss function and using known methods of training for neural networks such as backpropagation with stochastic gradient descent etc. 245. In each training epoch, the optimizer tries to choose the model parameters (i.e., weights) that minimize the training loss function (i.e. total error). Data is partitioned into training, validation, and test samples.

During training, the Optimizer minimizes the loss function on the training samples. After each training epoch, the mode is evaluated on the validation sample by computing the validation loss and accuracy. If there is no significant change, training can be stopped. Then this trained model may be used to predict the labels of the test data.

Thus, the classification neural network may be trained from audio input having known labels or classifications to identify and classify items within images in a digital content presentation.

Although the above discussion refers to classifying items within images, aspects of the present disclosure are not so limited. Specifically, aspects of the present disclosure include implementations in which digital content is reviewed for sounds that potentially subject to one or more intellectual property rights encumbrances.

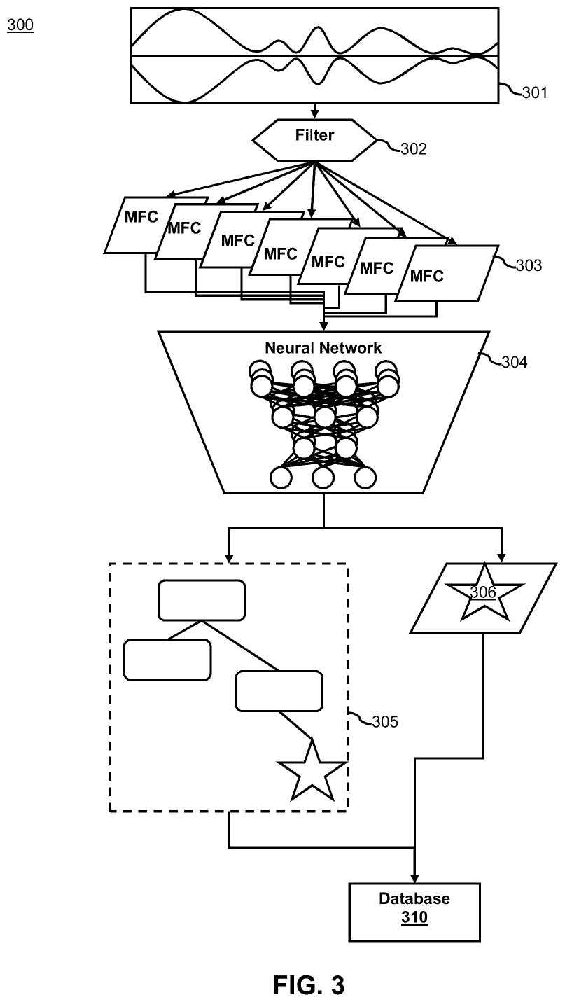

FIG. 3 depicts a possible scheme of operation of sound classification and categorization that may be used in conjunction system 100 begins with a segment of sound 101. Multiple filters are applied 102 to the segment of sound 101 to create windows sound and generate a representation of the sound in a Mel-frequency cepstrum 103. This frequency or spectral domain signal is then compressed by taking a logarithm of the spectral domain signal and then performing another FFT. The cepstrum can be seen as information about rate of change in the different spectral bands within the sound window. The Mel-frequency cepstrum representations are provided to trained sound categorization and classification Neural Networks 104. The trained sound categorization and classification NNs may output a vector 105 representing the category and subcategory of the sound as well as a vector representing the finest level category of the sound i.e., the classification 106. This categorization may then be used to search a database 110 during automated clearance review.

### Implementation

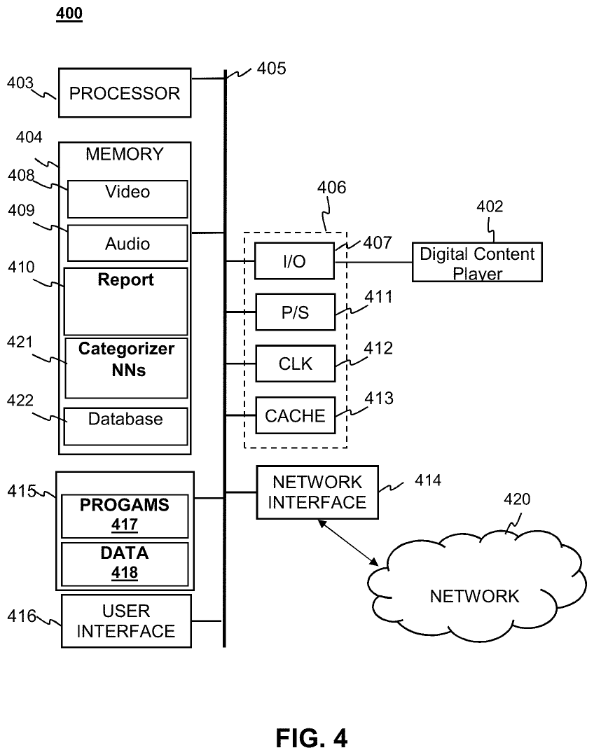

FIG. 4 depicts a system for automated clearance review of digital content according to aspects of the present disclosure. The system may include a computing device 400 coupled to a user input device 402. The user input device 402 may be a controller, touch screen, microphone, keyboard, mouse, joystick or other device that allows the user to input information including sound data in to the system. The user input device may be coupled to a haptic feedback device 421. The haptic feedback device 421 may be for example a vibration motor, force feedback system, ultrasonic feedback system, or air pressure feedback system.

The computing device 400 may include one or more processor units 403, which may be configured according to well-known architectures, such as, e.g., single-core, dual-core, quad-core, multi-core, processor-coprocessor, cell processor, and the like. The computing device may also include one or more memory units 404 (e.g., random access memory (RAM), dynamic random access memory (DRAM), read-only memory (ROM), and the like).

The processor unit 403 may execute one or more programs, portions of which may be stored in the memory 404 and the processor 403 may be operatively coupled to the memory, e.g., by accessing the memory via a data bus 405. The programs may be configured to implement sound filters 408 to convert the sounds to the Mel-frequency cep strum. Additionally the Memory 404 may contain programs that implement training of a sound categorization and classification NNs 421. The Memory 404 may also contain relevant portions of data for digital content, such as image data 408 and audio data 409. The memory 404 may also contain one or more databases 422 of cleared items. Neural network modules 421, e.g., parser AI's for images and audio, and categorization AI's for different classes of items (e.g., text, faces, vehicles, buildings, music, and dialog) may also be stored in the memory 404. The memory 404 may store a report 410 lasting items not identified by the neural network modules 421 as being in the databases 422. The digital content data, neural network modules, 421 422 may also be stored as data 418 in the Mass Store 418 or at a server coupled to the Network 420 accessed through the network interface 414.

The overall structure and probabilities of the NNs may also be stored as data 418 in the Mass Store 415. The processor unit 403 is further configured to execute one or more programs 417 stored in the mass store 415 or in memory 404 which cause processor to carry out a method of automated clearance review of digital content using the neural networks 422 as described herein. The system 400 may generate the Neural Networks 422 as part of a NN training process and store them in memory 404. Completed NNs may be stored in memory 404 or as data 418 in the mass store 415. The programs 417 (or portions thereof) may also be configured, e.g., by appropriate programming, to analyzing a digital content presentation with an artificial intelligence (AI) models 422 trained to identify items appearing in the digital content data 408, 409 that are known to be clear of intellectual property rights encumbrances and analyze that data with other AI models 422 trained to determine which items appearing in the digital content presentation that are not known to be clear are likely to be generic and determine which remaining items are potentially subject to intellectual property (IP) rights encumbrances and generating the report 410 to identify items that are potentially subject IP rights encumbrances.

The computing device 400 may also include well-known support circuits, such as input/output (I/O) 407, circuits, power supplies (P/S) 411, a clock (CLK) 412, and cache 413, which may communicate with other components of the system, e.g., via the bus 405. . The computing device may include a network interface 414. The processor unit 403 and network interface 414 may be configured to implement a local area network (LAN) or personal area network (PAN), via a suitable network protocol, e.g., Bluetooth, for a PAN. The computing device may optionally include a mass storage device 415 such as a disk drive, CD-ROM drive, tape drive, flash memory, or the like, and the mass storage device may store programs and/or data. The computing device may also include a user interface 416 to facilitate interaction between the system and a user. The user interface may include a monitor, Television screen, speakers, headphones or other devices that communicate information to the user.

The computing device 400 may include a network interface 414 to facilitate communication via an electronic communications network 420. The network interface 414 may be configured to implement wired or wireless communication over local area networks and wide area networks such as the Internet. The device 400 may send and receive data and/or requests for files via one or more message packets over the network 420. Message packets sent over the network 420 may temporarily be stored in a buffer 409 in memory 404. The categorized sound database may be available through the network 420 and stored partially in memory 404 for use.

Aspects of the present disclosure allow for significant automation of IP clearance review, a time-consuming task that is traditionally performed manually. By automatically identifying and ignoring items known or likely to be free of IP encumbrances and focusing a report on the remaining items the IP review tasks can be greatly streamlined.

While the above is a complete description of the preferred embodiment of the present disclosure, it is possible to use various alternatives, modifications and equivalents. It is to be understood that the above description is intended to be illustrative, and not restrictive. For example, while the flow diagrams in the figures show a particular order of operations performed by certain embodiments of the disclosure, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. The scope of the disclosure should, therefore, be determined with reference to the appended claims, along with the full scope of equivalents to which such claims are entitled. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for automated clearance review of digital content, comprising:
analyzing a digital content presentation with an artificial intelligence (AI) model trained to identify items appearing in the digital content presentation that are known to be clear of intellectual property rights encumbrances;
analyzing the digital content presentation with an AI model trained to determine which items appearing in the digital content presentation that are not known to be clear are likely to be generic;
analyzing the digital content presentation with an AI model that ignores identified items known to be clear or determined to likely be generic and is trained to determine which remaining items appearing in the digital content presentation are potentially subject to one or more intellectual property rights encumbrances; and
generating a report identifying the remaining items appearing in the digital content presentation that are potentially subject to one or more intellectual property rights encumbrances.

2. The method of claim 1, further comprising automatically digitally replacing items in the appearing in the digital content presentation that are potentially subject to one or more intellectual property rights encumbrances with corresponding items that are not subject to one or more intellectual property rights encumbrances.

3. The method of claim 1, wherein the report identifies one or more persons appearing in the digital content presentation that are potentially subject to one or more intellectual property rights encumbrances.

4. The method of claim 1, wherein the report identifies one or more places appearing in the digital content presentation that are potentially subject to one or more intellectual property rights encumbrances.

5. The method of claim 1, wherein the report identifies one or more objects appearing in the digital content presentation that are potentially subject to one or more intellectual property rights encumbrances.

6. The method of claim 1, wherein the report identifies one or more sounds appearing in the digital content presentation that are potentially subject to one or more intellectual property rights encumbrances.

7. The method of claim 1, wherein the report identifies music appearing in the digital content presentation that is potentially subject to one or more intellectual property rights encumbrances.

8. The method of claim 1, wherein the report identifies one or more buildings appearing in the digital content presentation that are potentially subject to one or more intellectual property rights encumbrances.

9. The method of claim 1, wherein the report identifies one or more vehicles appearing in the digital content presentation that are potentially subject to one or more intellectual property rights encumbrances.

10. The method of claim 1, wherein the report identifies one or more works of art appearing in the digital content presentation that are potentially subject to one or more intellectual property rights encumbrances.

11. The method of claim 1, wherein the report is configured so that multiple instances of items that are potentially subject to one or more intellectual property rights encumbrances are represented by a single object so that they appear only once in the report.

12. The method of claim 1, wherein the report is in electronic form and includes an interactive tool.

13. The method of claim 12, wherein the interactive tool is configured to show a user a number of instances of items flagged as being potentially subject to one or more intellectual property rights encumbrances.

14. The method of claim 12, wherein the interactive tool is configured to show a user a number of instances of items flagged as being potentially subject to one or more intellectual property rights encumbrances and show a representative image of each of such instance.

15. The method of claim 12, wherein the interactive tool is configured to show a user a number of instances of items flagged as being potentially subject to one or more intellectual property rights encumbrances and show a representative image of each of such instance, and wherein the interactive tool allows a user to quickly navigate through the digital content presentation to each such instance.

16. The method of claim 1, wherein analyzing the digital content presentation includes parsing data corresponding to one or more digital images to identify instances of one or more classes of items.

17. The method of claim 16, wherein the one or more classes of items include text, faces, vehicles, or buildings.

18. The method of claim 1, wherein analyzing the digital content presentation includes parsing data corresponding to one or more digital images to identify instances of one or more classes of items and categorizing each item in each of the one or more classes.

19. The method of claim 1, wherein analyzing the digital content presentation includes parsing digital audio data to identify instances of one or more classes of items.

20. The method of claim 19, wherein the one or more classes of items include music, dialog, or sound effects.

21. The method of claim 1, wherein analyzing the digital content presentation includes parsing digital audio data to identify instances of one or more classes of items and categorizing each item in each of the one or more classes.

22. A system for automated clearance review of digital content, comprising:
one or more processors;
a memory coupled to the one or more processors;
executable instructions stored in the memory configured upon execution by the one or more processors to cause the system to
(a) analyze a digital content presentation with an artificial intelligence (AI) model trained to identify items appearing in the digital content presentation that are known to be clear of intellectual property rights encumbrances;
(b) analyze the digital content presentation with an AI model trained to determine which items appearing in the digital content presentation that are not known to be clear are likely to be generic;
(c) analyzing the digital content presentation with an AI model that ignores identified items known to be clear or determined to likely be generic and is trained to determine which remaining items appearing in the digital content presentation are potentially subject to one or more intellectual property rights encumbrances; and
(d) generating a report identifying the remaining items appearing in the digital content presentation that are potentially subject to one or more intellectual property rights encumbrances.

23. A non-transitory computer-readable medium having computer readable instructions embodied therein, the instructions being configured upon execution by one or more processors to
(a) analyze a digital content presentation with an artificial intelligence (AI) model trained to identify items appearing in the digital content presentation that are known to be clear of intellectual property rights encumbrances;
(b) analyze the digital content presentation with an AI model trained to determine which items appearing in the digital content presentation that are not known to be clear are likely to be generic;
(c) analyzing the digital content presentation with an AI model that ignores identified items known to be clear or determined to likely be generic and is trained to determine which remaining items appearing in the digital content presentation are potentially subject to one or more intellectual property rights encumbrances; and
(d) generating a report identifying the remaining items appearing in the digital content presentation that are potentially subject to one or more intellectual property rights encumbrances
